(19) United States
(12) Patent Application Publication
(10) Pub. No.: US 2006/0096650 A1
(43) Pub. Date: May 11, 2006

(54) Non-linear noise suppressor for perforated plate flow conditioner

(76) Inventors: Blaine Daren Sawchuk, Calgary (CA); Dale Peter Sawchuk, Calgary (CA)

Correspondence Address: TIM HEADLEY, GARDERE WYNNE SEWELL LLP, 1000 LOUISIANA, SUITE 3400, HOUSTON, TX, 77002, US

(21) Appl. No.: 11/315,432

(22) Filed: Dec. 22, 2005

Related U.S. Application Data
(63) Continuation-in-part of application No. 10/936,832, filed on Sep. 9, 2004.
(60) Provisional application No. 60/553,952, filed on Mar. 18, 2004.

(51) Int. Cl. F15D 1/04

(52) U.S. Cl. 138/39; 138/42

(57) ABSTRACT

A perforated plate flow conditioner includes a central hole; and at least one outer array of alternating large outer holes and small outer holes, wherein the difference between the diameters of the holes in the array is between 0.25% and 25% of the large hole diameter. In an alternate embodiment, the conditioner further includes an inner array of alternating large inner holes and small inner holes, and wherein no two adjacent holes have the same diameter. In another alternate embodiment, the conditioner has no central hole, and has an array of alternatingly-sized holes.

### CROSS-REFERENCES TO RELATED APPLICATIONS

This application is a continuation-in-part of, and claims the benefit of, pending application Ser. No. 10/936,832, which is incorporated herein by this reference.

### STATEMENT REGARDING FEDERALLY SPONSORED RESEARCH OF DEVELOPMENT

Not applicable.

### FIELD OF THE INVENTION

The present invention relates to pipeline perforated plate noise elimination generally, and in particular relates to the elimination of noise generated by the special application of a perforated plate flow conditioner to assist in flow measurement.

### BACKGROUND OF THE INVENTION

Specially devised screens are used in the pipeline industry to reconfigure the fluid flow profile in the pipeline. When used to correct the fluid flow profile in the pipe they are referred to as perforated plate flow conditioners. An example of such a flow conditioner is the invention described in U.S. Pat. No. 5,762,107, which is incorporated herein by this reference. That patent disclosed adding vanes parallel to the flow, both upstream and downstream to the perforated plate. Similarly, U.S. Pat. No. 6,701,963, which is incorporated herein by this reference, discloses a low pressure drop flow conditioner using porous axial vanes.

In operation the perforated plates are installed in the pipeline in front of the flow meter. The perforations (holes) in the plate cause the fluid flow to be reconfigured or readjusted in the radial directions so as to develop a fluid flow velocity profile which is preferred. In some cases this preferred fluid flow velocity profile can be that which is normally seen in a long straight piece of flowing pipe, or can be of a condition which is simply repeatable (can be exactly recreated time after time). The net positive effects of the flow conditioning device is that the flow meter which is located downstream of the flow conditioner operates in a more accurate and repeatable fashion. There are numerous perforated plates used in industry some patented, some public domain. Noise generation is a detrimental aspect of perforated plates.

When fluid flows past a perforated plate, which can be a disk containing holes of any type of diameter, array, or configuration, noise is generated. The noise generation is a normal physical characteristic of the fluid flow case, but it is a detrimental attribute which can in some cases offset the positive measurement effects of the perforated plate flow conditioner.

The undesirable noise is generated by harmonic interaction between the hole, fluid jets downstream of the screen, a flat spot of the plate on a rear section between the holes, and the location of the impact point of the fluid jets, which is a coalescing point. The physics of noise generation can be understood by reference to one hole pair and the “flat spot” between the two holes. The flow conditioner can be made of any number of holes. At least one hole pair and the accompaning rear flat spot between the holes create the noise phenonenom.

Referring now to FIG. 1, a prior art perforated plate flow conditioner 9 has holes 10. As fluid passes through the holes 10, each hole initiates a high speed stream 11 of fluid at an initiation point, which is the upstream hole inlet edge 12. Prior attempts to solve the noise phenomenon focused efforts at the upstream hole inlet edge 12, but with only marginally successsful results, because the fundamental physcial noise generation phenomenon downstream of the perforated plate was overlooked.

As fluid travels through each hole 10, the fluid accelerates and develops the stream 11 which is bounded by the inside walls of the hole. Upon exit from the hole the fluid streams 11 expand to meet the pipe flow conditions downstream. Exit vortices are generated as the streams 11 exit from the flow conditioner. If the expanding streams 11 are exiting adjacent holes, the point where the adjacent exiting streams touch is a coalescing point 14. The vortices contained within the exiting streams 11 are dynamic in nature, and can therefore generate some acoustic noise of a frequency dependent on the hole diameters and the distance between the holes.

From a downstream side 15 of the perforated plate flow conditioner 9 to the coalescing point 14 is a distance 16 which is a function of, and is dependent on, the fluid flow velocity and the diameter of the stream 10. At the coalescing point 14 some small amount of acoustic energy is generated from the contacting jets. When the distance 16 is at some whole number product of the wavelength distance of the acoustic emmitance of the coalescing point 14, acoustic resonance occurs. The accoustic energy from the coalescing point 14 feeds back to a downstream side 15 flat spot 18 between holes, where it is reflected back to coalescing point 14, but it also disturbs the jet vortices at the hole exit location. The disturbed jets meet at the coalescing point 14, then emit acoustic energy, and the cycle continues. This feedback cycle continues until the acoustic energy becomes detrimental noise. This noise is detrimental to flow meter performance and is environmentally unacceptable.

Thus, flowmeters such as disclosed in U.S. Pat. No. 6,647,806, which is incorporated herein by this reference, which use a turbulence conditioner for use with transit time ultrasonic flowmeters, suffer from decreased performance due to the noise generated by the flow conditioner.

Numerous patented and unpatented perforated plate flow conditioners, and other types of devices which are used to modify flow in pipe for fluid flow measurment (not all flow conditioning devices are perforated plates) are produced by various companies.

Attempts to modify the generation of perforated plate noise by modifying the edge sharpness at the upstream hole inlet edge 12, have been the only attempts at noise elimination to date. Effectiveness of this approach has been only marginal, because the modification of edge sharpness at the hole inlet edge 12 simply changes the distance 16 from the downstream side 15 to the coalescing point 14, thereby changing the harmonics acoustic noise generation feedback system—the location of the coalescing point 14 and the wavelength of the emitted noise. When the pipe fluid velocity happens to make the acoustic wavelength equal to that distance, noise is again emitted, although at a new frequency which may not be as detrimental.

Previous attempts to silence perforated plate noise have been only partly successful. United States Patent Application 20040055816 by James Gallagher et al., published Mar. 25, 2004, which is incorporated herein by this reference, discloses an apparatus for filtering ultrasonic noise within a fluid flow system.

The application states, “the noise filter 410 provides an absorbent element having absorbent material thereon which converts indirect noise propagation into vibration (and, also thereby converting the indirect noise energy into small amounts of thermal energy). The device appears to be similar to a packed muffler, and the absorbent material has apparently had longevity problems.

U.S. Pat. No. 6,533,065 to Zanker, which is incorporated herein by this reference, discloses a noise silencer for use with an ultrasonic meter. The silencer comprises a tubular body having at least two baffles spaced apart from one another. The baffles are preferably formed of an open-cell, reticulated metal foam material that absorbs noise in the ultrasonic range of frequencies under high-pressure operating conditions. However, this silencer, in addition to being expensive, is passive, and converts the noise generated into heat after the fact. That is, it does not deal with the source of the problem. This silencer is prone to self-destruction because the gas velocities in the pipe are large, and damage protruding devices like this device. Finally, this silencer creates a high pressure drop.

Chamfering the downstream edge of a hole has done little to eliminate noise. Chamfering the upstream hole inlet edge has reduced the flow conditioner noise slightly. Rounding the leading edge of the perforated plate holes has increased the noise generation significantly.

Currently, no device exists to eliminate the source of the noise where it is generated: at the flat spots 18 between the holes on the downstream side 15, thus interfering with the acoustic feedback loop. What is needed is a device that eliminates the fundamantal noise generation phenomenon on the down stream facing side of the perforated plate.

### SUMMARY OF THE PRESENT INVENTION

The present invention provides a perforated plate flow conditioner comprising: a central hole; and at least one outer array of alternating large outer holes and small outer holes, wherein the difference between the diameters of the holes in the array is preferably between 0.25% and 25% of the large hole diameter. In an alternate embodiment, the conditioner further comprises an inner array of alternating large inner holes and small inner holes, wherein no two adjacent holes have the same diameter.

### BRIEF DESCRIPTION OF THE DRAWINGS

FIG. 1(a) illustrates fluid streams through a prior art perforated plate flow conditioner, and the acoustic noise generated by the fluid streams.

FIG. 1(b) illustrates the measurement of the noise generated by fluid flowing through the plate of FIG. 1(a).

FIG. 2(a) illustrates a plan view of a perforated plate flow conditioner, built according to the present invention.

FIG. 2(b) illustrates a side view of the plate of FIG. 2(a), showing how the mismatching of the adjacent hole diameters causes the jetting of the fluid to not meet, thus not creating a coallesing point for sound to be generated.

FIG. 2(c) illustrates the measurement of the noise generated by fluid flowing through the plate of FIG. 2(a).

FIG. 3(a) illustrates a plan view of an alternate embodiment of a perforated plate flow conditioner, built according to the present invention, comprising a circular array of alternatingly-sized holes, surrounding a center square array of sixteen equally-sized central holes.

FIG. 3(b) illustrates a plan view of an alternate embodiment of a perforated plate flow conditioner, built according to the present invention, wherein the array comprises two circular arrays of alternatingly-sized holes around three equally-sized central holes.

FIG. 3(c) illustrates a plan view of an alternate embodiment of a perforated plate flow conditioner, built according to the present invention, wherein the array comprises two circular arrays of alternatingly-sized holes around four equally-sized central holes.

FIG. 3(d) illustrates a plan view of an alternate embodiment of a perforated plate flow conditioner, built according to the present invention, wherein the array of holes has no central holes, and comprises a rectangular array, having two symetrically opposed rows shorter than the other rows.

### DETAILED DESCRIPTION

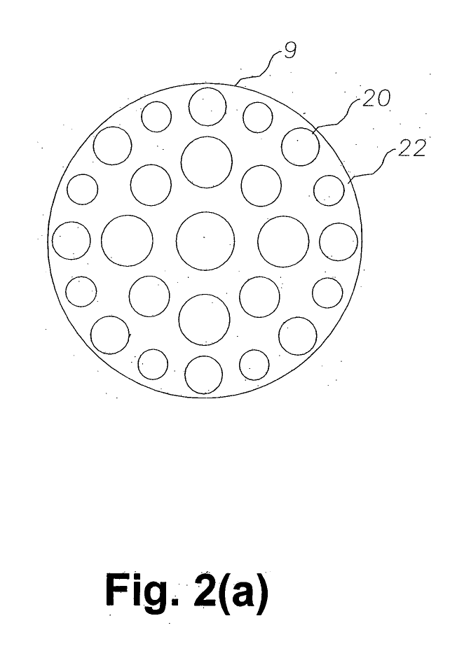

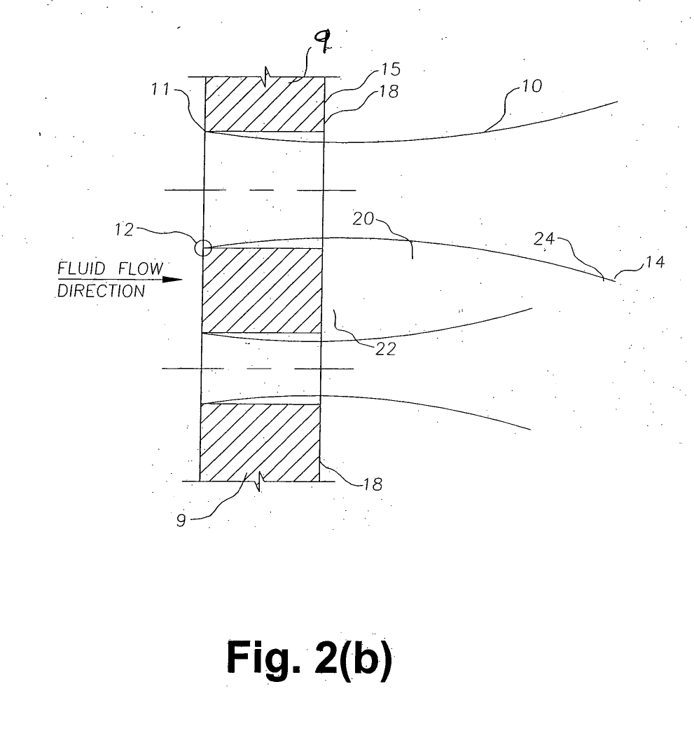

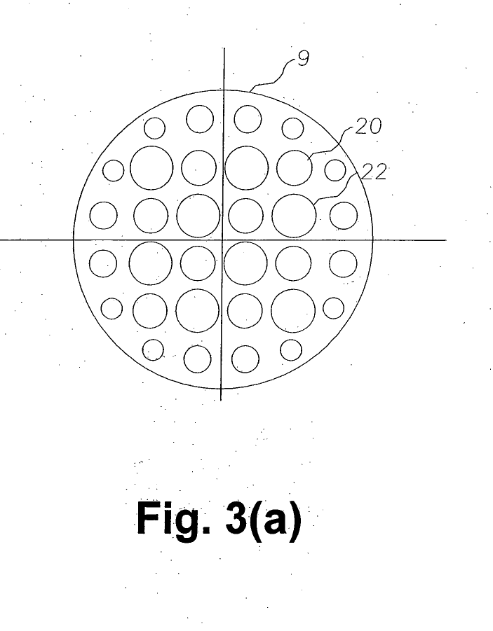

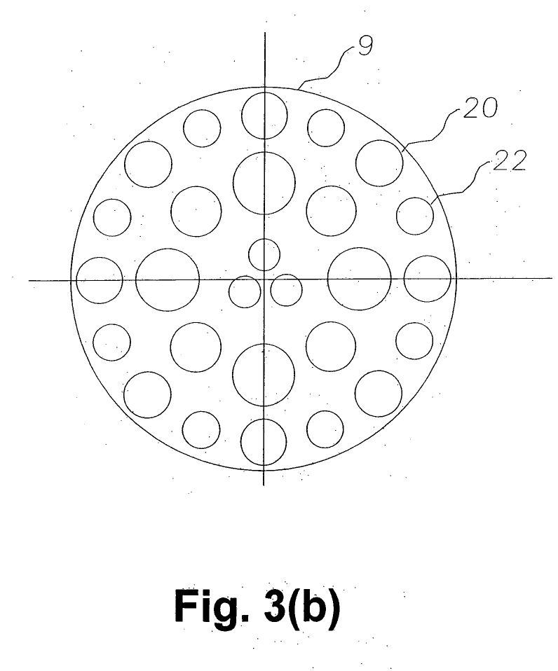

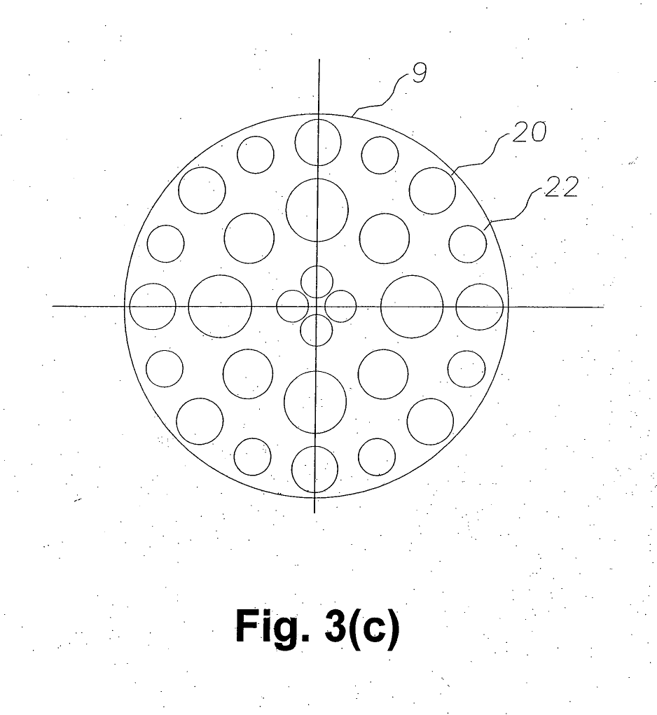

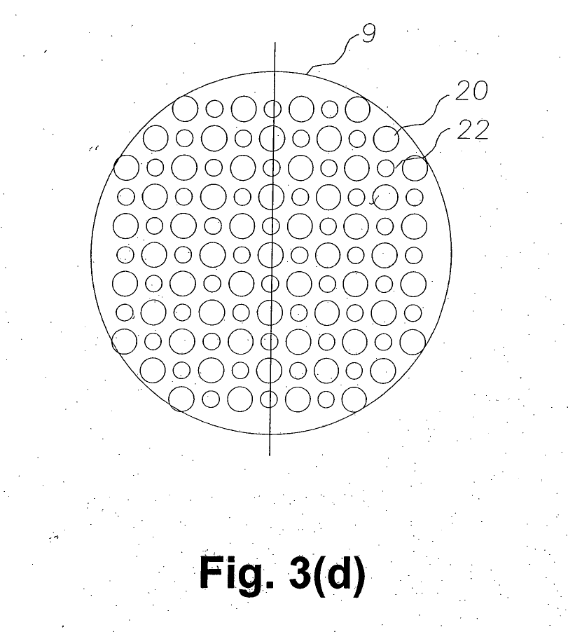

Referring now to FIG. 2(a), a perforated plate flow conditioner 9 includes a single central hole, an inner circular array of alternating large holes and smaller holes, and an outer circular array of alternating large holes and smaller holes. The difference between the diameters of the large and small holes in each circular array is preferably between 0.25% and 25% of the large hole diameter. In the preferred embodiment, the inner circular array contains eight holes, and the outer circular array contains sixteen holes. It is preferable to keep the hole size differences to a minimum to ensure the beneficial fluid flow properties of the flow conditioner are maintained. In an alternate embodiment, the arrays are rectangular or square.

Referring now to FIG. 2(b), the mismatching of the adjacent hole diameters causes the jetting of the fluid to not meet, thus not creating a coallesing point for sound to be generated.

Operating Test Results

The graphs indicated in FIG. 2(c) are the sound pressure levels, or noise, experienced outside of the perforated plates for various configurations for sound frequencies ranging from 0 to 10,000 hz. These are Fast Fourier Transforms. The gas flow rate was 85 ft/sec. The total broadband noise at this snapshot of time was 87 dB. The installation was 745 psi natural gas flowing at the TransCanada Calibrations Test facility located in Winnepeg, Manitoba, Canada. The tests were conducted Oct. 19, 2005. The snap shot was taken at the worst case of audible noise. The microphone was located downstream from the perforated plate flow conditioner. The location distance was measured at a 45 degree angle from the flow direction, and was approximately one meter.

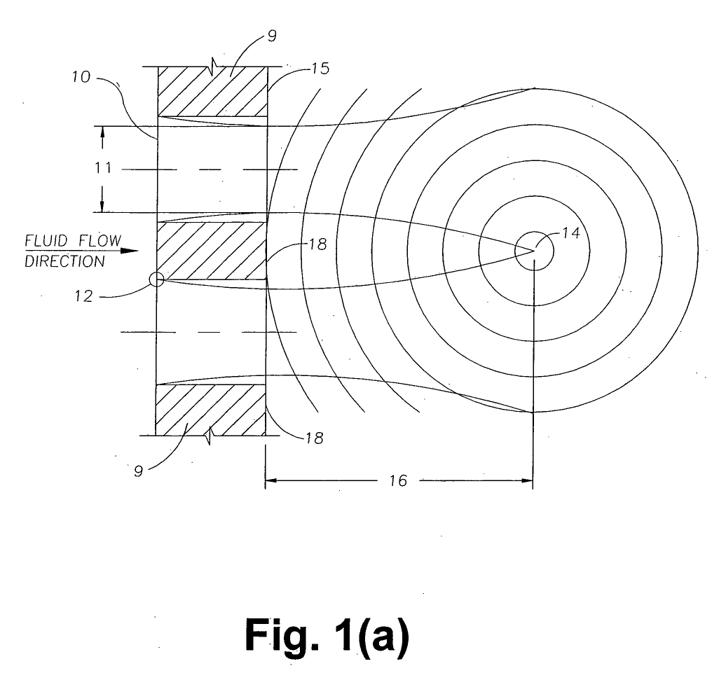

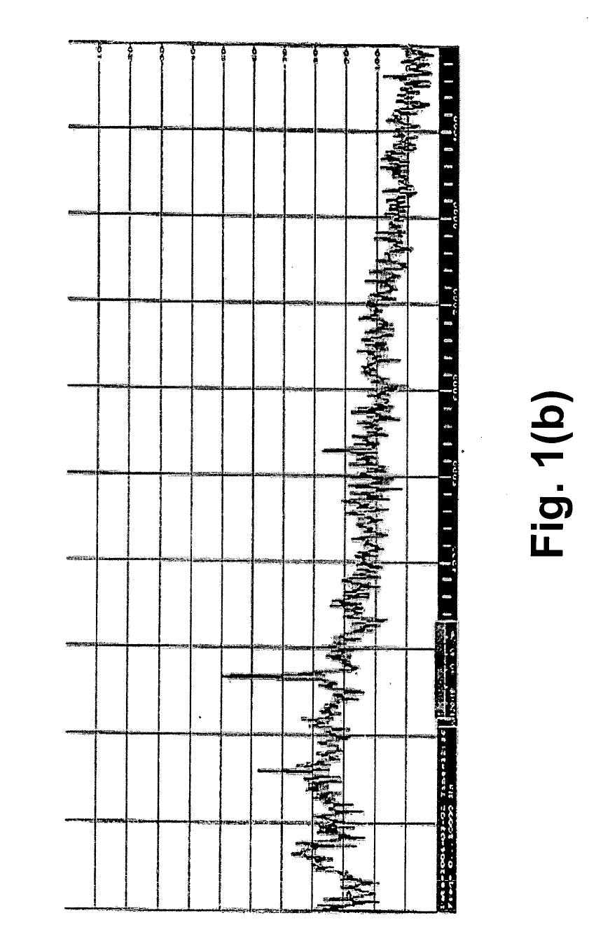

Referring now to FIG. 1(b), this graph was the noise measured for the prior art perforated plate flow conditioner 9. The “peaks” at approximately 1600 hz, 2700 hz and 3200 hz represent the undesirable noise that needed to be eliminated. Referring now to FIG. 2(c), this graph was the noise measured for the perforated plate flow conditioner 9 shown in FIGS. 2(a) and (b). As can be seen from the graph, the perforated plate flow conditioner 9 shown in FIGS. 2(a) and 2(b) eliminated the noise at 1600 hz, 2700 hz and 3200 hz., and reduced background broadband noise reduced to virtual silence. The measured background noise was merely 60 db, which was produced by the building fans and HVAC equipment. No noise that was measured came from the perforated plate flow conditioner.

1. A perforated plate flow conditioner comprising:
a central hole; and
at least one outer array of alternating large outer holes and small outer holes,
wherein the difference between the diameters of the holes in the array is between 0.25% and 25% of the large hole diameter.

2. The conditioner of claim 1, wherein the array is circular.

3. The conditioner of claim 1, wherein the array is square.

4. The conditioner of claim 1, wherein the array is rectangular.

5. A perforated plate flow conditioner comprising:
a central hole;
an inner array of alternating large inner holes and small inner holes; and
an outer array of alternating large outer holes and small outer holes,
wherein the difference between the diameters of the holes in a given array is between 0.25% and 25% of the large hole diameter.

6. The conditioner of claim 5, wherein the arrays are circular.

7. The conditioner of claim 5, wherein the arrays are square.

8. The conditioner of claim 5, wherein the arrays are rectangular.

9. The conditioner of any of claims 1-8, wherein the outer array comprises sixteen holes.

10. The conditioner of any of claims 5-8, wherein the inner array comprises eight holes.

11. The conditioner of any of claims 1-8, wherein no two adjacent holes have the same diameter.

12. A perforated plate flow conditioner comprising:
an array of alternating large holes and small holes, wherein the difference between the diameters of the large and small holes is between 0.25% and 25% of the large hole diameter.

13. The conditioner of claim 12, wherein the array is circular, and wherein no two adjacent holes have the same diameter.

14. The conditioner of claim 12, wherein the array is square, and wherein no two adjacent holes have the same diameter.

15. The conditioner of claim 12, wherein the array is rectangular, and wherein no two adjacent holes have the same diameter.
